(19) United States
(12) Patent Application Publication
(10) Pub. No.: US 2023/0042097 A1
(43) Pub. Date: Feb. 9, 2023

(54) OPERATION CONTROL DEVICE AND PROGRAM

(71) Applicant: FANUC CORPORATION, Minamitsuru-gun, Yamanashi (JP)

(72) Inventor: Kouichirou HORIGUCHI, Yamanashi (JP)

(21) Appl. No.: 17/790,335

(22) PCT Filed: Feb. 4, 2021
(86) PCT No.: PCT/JP2021/004129

§ 371 Date: Jun. 30, 2022

(30) Foreign Application Priority Data
Feb. 7, 2020 (JP) 2020-019953

(51) Int. Cl. G05B 19/418

(52) U.S. Cl. CPC G05B 19/4182; G05B 2219/13063

(57) ABSTRACT

Provided are an operation control device and program capable of properly synthesizing drive signals of two lineages. An operation control device for controlling an operation of a manufacturing system including an industrial machine using drive signals of at least two lineages, the device comprising a first drive signal output unit for outputting a first drive signal as a drive signal of a first lineage, a second drive signal output unit for outputting a second drive signal as a drive signal of a second lineage, a synthesized drive signal generation unit for generating a synthesized drive signal by synthesizing the first drive signal and the second drive signal, and an operation control unit for controlling an operation of the manufacturing system on the basis of the first drive signal, the second drive signal, and the synthesized drive signal.

### TECHNICAL FIELD

The present disclosure relates to an operation controller and a program.

### BACKGROUND ART

Conventionally, a production system that performs machining on workpieces is known. The production system includes: a conveyor device that transfers a workpiece; at least one industrial machine provided along the conveyor device; and an operation controller that controls operations of the conveyor device and the industrial machine.

The industrial machine includes a tool for machining the workpiece. The industrial machine performs machining of the transferred workpiece by using the tool. Thereby, the industrial machine can perform machining to process the workpiece into a desired shape.

For example, the operation controller has a function of controlling the conveyor device and a function of controlling the industrial machine. The operation controller sequentially performs these functions so as to cause the industrial machine to machine the workpiece. That is, the operation controller operates the production system using drive signals of 2 paths.

When controlling the production system by using the drive signals of 2 paths, it is preferable that the operation controller synchronize one of the drive signals with the other drive signal. It is preferable that the operation controller treat the one drive signal and the other drive signal as a single drive signal, for example. Thereby, the production efficiency can be improved. As such a device, there is proposed a CNC system that superimposes a CNC (computer numerical controller) side axis movement command and a PMC (programmable machine controller) side movement command to execute movement control of each axis (see, for example, Patent Document 1).
Patent Document 1: Japanese Unexamined Patent Application, Publication No. H07-230312

### DISCLOSURE OF THE INVENTION

### Problems to be Solved by the Invention

The CNC system disclosed in Patent Document 1 superimposes the CNC side axis movement command and the PMC side axis movement command. Thereby, the CNC system disclosed in Patent Document 1 can operate CNC control together with PMC control.

In a case of using the drive signals of 2 paths operated sequentially, drive using one drive signal is executed after completing axis movement using the other drive signal. Therefore, by simply superimposing the drive signals of 2 paths, it is difficult to operate the drive signals of 2 paths appropriately. Thus, it is suitable to be able to combine the drive signals of 2 paths with each other appropriately.

### Means for Solving the Problems

(1) The present disclosure relates to an operation controller controlling an operation of a production system including an industrial machine by using drive signals of at least 2 paths, and the operation controller includes: a first drive signal output unit that outputs a first drive signal as a drive signal of a first path;

a second drive signal output unit that outputs a second drive signal as a drive signal of a second path; a composite drive signal generation unit that generates a composite drive signal by combining the first drive signal and the second drive signal; and an operation control unit that controls the operation of the production system based on the first drive signal, the second drive signal, and the composite drive signal.

(2) Furthermore, the present disclosure relates to a program causing a computer to function as an operation controller that controls an operation of a production system including an industrial machine by using drive signals of at least 2 paths, and the program causing the computer to function as: a first drive signal output unit that outputs a first drive signal as a drive signal of a first path; a second drive signal output unit that outputs a second drive signal as a drive signal of a second path; a composite drive signal generation unit that generates a composite drive signal by combining the first drive signal and the second drive signal; and an operation control unit that controls the operation of the industry system based on the first drive signal, the second drive signal, and the composite drive signal.

### Effects of the Invention

According to the present disclosure, it is possible to provide the operation controller and the program capable of appropriately combining the drive signals of 2 paths with each other.

### BRIEF DESCRIPTION OF THE DRAWINGS

FIG. 1 is a schematic diagram illustrating a production system including an operation controller according to a first embodiment of the present disclosure;

FIG. 2 is a conceptual diagram illustrating an overview of an operation of the production system including the operation controller according to the first embodiment;

FIG. 3 is a conceptual diagram illustrating an overview of the operation of the production system including the operation controller according to the first embodiment;

FIG. 4 is a block diagram illustrating a constitution of the operation controller according to the first embodiment;

FIG. 5 is a flowchart illustrating the operation of the operation controller according to the first embodiment;

FIG. 6 is a block diagram illustrating a constitution of a controller according to a second embodiment of the present disclosure;

FIG. 7 is a block diagram illustrating a constitution of a controller according to a third embodiment of the present disclosure; and

FIG. 8 is a schematic diagram illustrating a shared axis controlled by a controller according to Modification Example.

### PREFERRED MODE FOR CARRYING OUT THE INVENTION

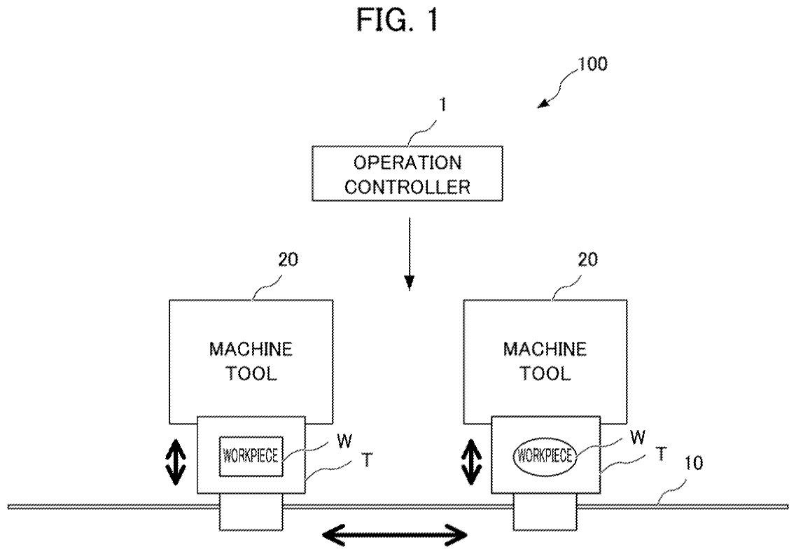

Hereinafter, an operation controller 1 and a program according to each embodiment of the present disclosure will be described by referring to FIGS. 1 to 7. First, prior to describing the operation controller 1 and the program according to each embodiment, an overview of a production system 100 that includes the operation controller 1 will be described.

The production system 100 is a system that performs machining while transferring a workpiece W, for example. As illustrated in FIG. 1, the production system 100 includes a conveyor device 10, an industrial machine 20, and the operation controller 1.

The conveyor device 10 is a device that transfers the workpiece W. The conveyor device 10 transfers the workpiece W by rotating a motor (not shown), for example. The conveyor device 10 transfers the workpiece W toward a prescribed direction.

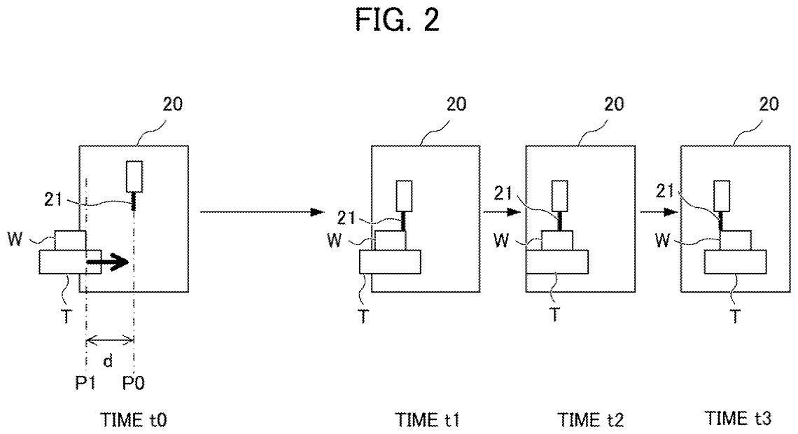

The industrial machine 20 is a machine tool, for example. As illustrated in FIG. 1, there are two industrial machines 20 provided along the transfer direction of the workpiece W. The industrial machine 20 performs machining of the workpiece W to process it into a preset shape by using a tool 21 (see FIG. 2), for example. Note that the industrial machine 20 includes various machines such as a machine tool, an industrial robot, a service robot, a forging machine, and an injection molding machine, for example.

The operation controller 1 is a device that controls operations of the conveyor device 10 and the industrial machine 20. The operation controller 1 controls the operation of the production system 100 by using drive signals of at least 2 paths, for example. As a drive signal of a first path, for example, the operation controller 1 uses a PLC (programmable logic controller) for simple operations such as simple machining and transfer as well as for management of devices on the production system 100. Specifically, the operation controller 1 uses the PLC for transferring the workpiece W by the conveyor device 10. Furthermore, as a drive signal of a second path, for example, the operation controller 1 uses a NC (numeric control) drive signal for machining of complicated shapes and for complicated operations. Specifically, the operation controller 1 uses the NC for moving the axis of the tool 21 of the industrial machine 20.

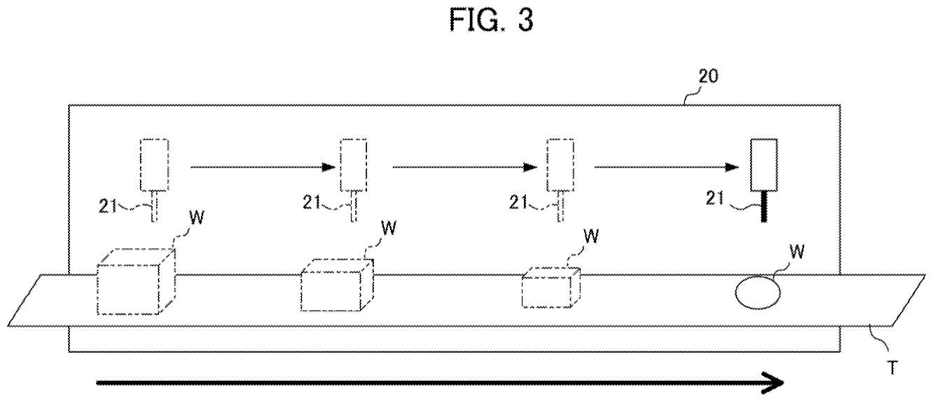

Note here that the operation controller 1 combines (superimposes) and executes the first path drive signal and the second path drive signal, for example. As illustrated in FIGS. 2 and 3, for example, the operation controller 1 causes the tool 21 to perform machining of the workpiece W by the NC while transferring the workpiece W placed on a transfer table T by the PLC (axis control). That is, at time t0, the operation controller 1 starts machining of the workpiece W using the tool 21 by moving the tool 21 at a machining position P1 that is moved to the workpiece W side by a distance d with respect to a reference position P0 of the tool 21. Then, at time t1, t2, and t3, the operation controller 1 executes both transfer and machining by causing the tool 21 to perform machining of the workpiece W in accordance with transfer of the workpiece W.

### First Embodiment

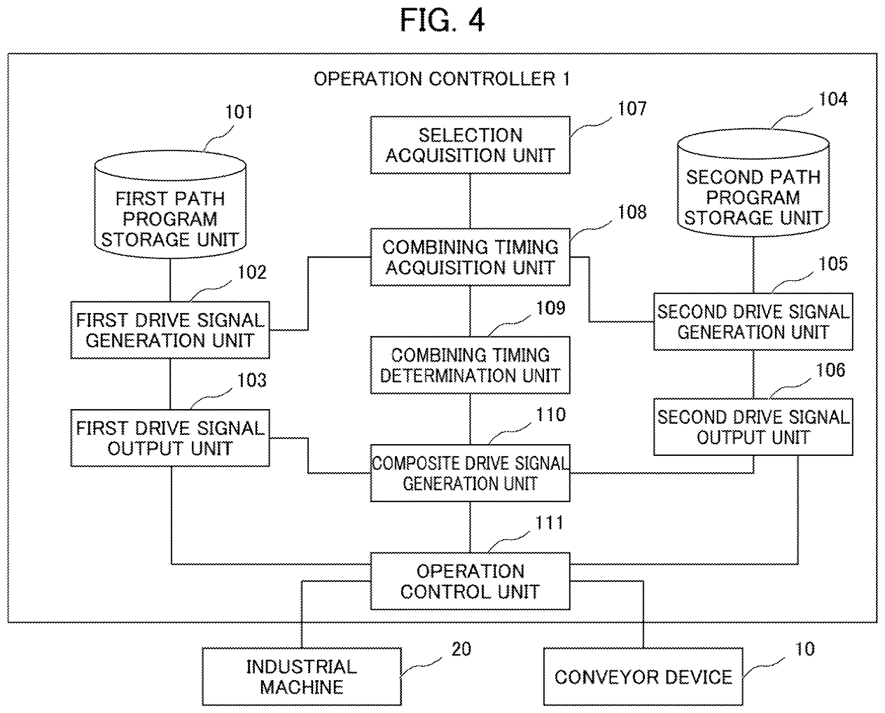

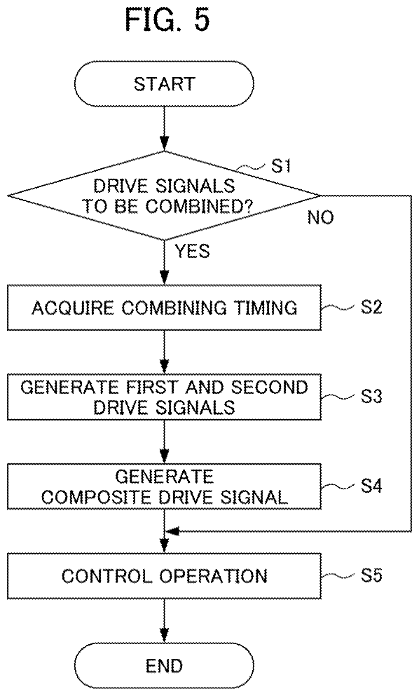

Next, the operation controller 1 and the program according to the first embodiment of the present disclosure will be described by referring to FIGS. 4 and 5. The operation controller 1 according to the present embodiment controls the operation of the production system 100 including the industrial machine 20 by using the drive signals of at least 2 paths. As illustrated in FIG. 4, the operation controller 1 includes a first path program storage unit 101, a first drive signal generation unit 102, a first drive signal output unit 103, a second path program storage unit 104, a second drive signal generation unit 105, a second drive signal output unit 106, a selection acquisition unit 107, a combining timing acquisition unit 108, a combining timing determination unit 109, a composite drive signal generation unit 110, and an operation control unit 111.

The first path program storage unit 101 is a secondary storage medium such as a hard disk, for example. The first path program storage unit 101 houses a program for generating the first path drive signal. In the present embodiment, the first path program storage unit 101 houses a program for the PLC control, for example. Specifically, a program for moving the axis of the conveyor device 10 to transfer the workpiece W is housed in the first path program storage unit 101.

The first drive signal generation unit 102 is implemented by an operation of a CPU, for example. The first drive signal generation unit 102 generates a first drive signal that is the first path drive signal. In the present embodiment, the first drive signal generation unit 102 generates the drive signal that drives the axis of the conveyor device 10.

The first drive signal output unit 103 is implemented by an operation of the CPU, for example. The first drive signal output unit 103 outputs the first drive signal that is the first path drive signal. The first drive signal output unit 103 outputs the first drive signal with a prescribed control frequency, for example. Specifically, the first drive signal output unit 103 outputs the first drive signal with a control frequency shorter than that of the second drive signal output unit 106 to be described later.

The second path program storage unit 104 is a second storage medium such as a hard disk, for example. The second path program storage unit 104 houses a program for generating the second path drive signal. In the present embodiment, the second path program storage unit 104 houses the program for the NC control, for example. Specifically, in the second path program storage unit 104, the program for moving the axis of the tool 21 of the industrial machine 20 and for performing machining of the workpiece W is housed.

The second drive signal generation unit 105 is implemented by an operation of the CPU, for example. The second drive signal generation unit 105 generates a second drive signal that is the second path drive signal. In the present embodiment, the second drive signal generation unit 105 generates the drive signal that drives the axis of the tool 21 of the industrial machine 20.

The second drive signal output unit 106 is implemented by an operation of the CPU, for example. The second drive signal output unit 106 outputs the second drive signal that is the second path drive signal. The second drive signal output unit 106 outputs the second drive signal with a drive frequency longer than that of the first drive signal output unit 103, for example.

The selection acquisition unit 107 is implemented by an operation of the CPU, for example. The selection acquisition unit 107 acquires selection regarding whether a composite drive signal is to be generated. When the first drive signal and the second drive signal are to be combined, the selection acquisition unit 107 selects “combine”, for example. When the first drive signal and the second drive signal are not to be combined, the selection acquisition unit 107 selects “not combine”.

The combining timing acquisition unit 108 is implemented by an operation of the CPU, for example. The combining timing acquisition unit 108 acquires the timing for combining the first drive signal and the second drive signal from outside. When “combine” is selected, the combining timing acquisition unit 108 acquires the timing for combining the first drive signal and the second drive signal. The combining timing acquisition unit 108 acquires program blocks, transfer position, or the like to be combined as the combining timing, for example. Specifically, referring to FIG. 2, the combining timing acquisition unit 108 acquires the first drive signal for transferring the mount table having the workpiece W placed thereon to the position P1 and the second drive signal for driving the tool 21 to perform machining of the workpiece W as the combining timing. The combining timing acquisition unit 108 acquires the combining timing by using an input device (not shown) such as a keyboard.

The combining timing determination unit 109 is implemented by an operation of the CPU, for example. The combining timing determination unit 109 determines the combining timing of the first drive signal and the second drive signal. The combining timing determination unit 109 determines the timing acquired by the combining timing acquisition unit 108 as the combining timing.

The composite drive signal generation unit 110 is implemented by an operation of the CPU, for example. When selection to generate a composite drive signal is acquired, the composite drive signal generation unit 110 generates the composite drive signal. Furthermore, the composite drive signal generation unit 110 combines the first drive signal with the second drive signal to generate the composite drive signal based on the determined combining timing. The composite drive signal generation unit 110 generates the composite drive signal by combining the first drive signal and the second drive signal while a prescribed compensation being applied to at least one of the first drive signal and the second drive signal. The composite drive signal generation unit 110 generates the composite drive signal by combining the first drive signal and the second drive signal, at least one of which is multiplied by a prescribed multiplication factor, for example. Furthermore, the composite drive signal generation unit 110 generates the composite drive signal by combining the first drive signal and the second drive signal, at least one of which has its sign inverted, for example. Furthermore, the composite drive signal generation unit 110 generates the composite drive signal for changing a relative position of an object controlled by the second drive signal with respect to a position of an object controlled by the first drive signal, for example. Specifically, the composite drive signal generation unit 110 generates the composite drive signal for changing the relative position of the tool 21 controlled by the second drive signal with respect to the position of the workpiece W transferred by the first drive signal. More specifically, the composite drive signal generation unit 110 generates the composite drive signal for compensating a difference between the position of the workpiece W transferred by the first drive signal and the reference position of the tool 21 controlled by the second drive signal. The composite drive signal generation unit 110 generates the composite drive signal for moving the tool 21 from the reference position P0 to the machining position P1 toward the opposite side of the transfer direction of the workpiece W in FIG. 2, for example. That is, the composite drive signal generation unit 110 generates the composite drive signal for driving the axis to move the tool 21 by the distance d toward the opposite side of the transfer direction of the workpiece W.

The operation control unit 111 is implemented by an operation of the CPU, for example. The operation control unit 111 controls the operation of the production system 100 based on the first drive signal, the second drive signal, and the composite drive signal. Referring to FIG. 2, for example, the operation control unit 111 controls the operation of the conveyor device 10 based on the first drive signal. That is, the operation control unit 111 controls transfer of the workpiece W based on the first drive signal. Furthermore, the operation control unit 111 controls the machining operation of the tool 21 based on the second drive signal. That is, the operation control unit 111 controls axis movement for the machining operation of the tool 21 based on the second drive signal. Furthermore, the operation control unit 111 controls the moving operation of the tool 21 based on the composite drive signal. That is, the operation control unit 111 controls movement of the position of the tool 21 in accordance with transfer of the workpiece W based on the composite drive signal. The operation control unit 111 controls the workpiece W and the operation of the tool 21 by giving an operation command to the motors of the conveyor device 10 and the industrial machine 20.

Next, a flow of the operation of the numerical controller according to the present embodiment will be described by referring to the flowchart of FIG. 5. First, the selection acquisition unit 107 acquires selection regarding whether to combine the first drive signal with the second drive signal. The combining timing acquisition unit 108 determines whether to combine the first and second drive signals (Step S1). When the first and second drive signals are to be combined (Step S1: Yes), the combining timing acquisition unit 108 acquires the combining timing. Then, the processing proceeds to Step S2. On the other hand, when the first and second drive signals are not to be combined (Step S1: No), the combining timing acquisition unit 108 causes the first drive signal generation unit 102 and the second drive signal generation unit 105 to generate the first drive signal and the second drive signal, respectively. Then, the processing proceeds to Step S5.

In Step S2, the combining timing acquisition unit 108 acquires the combining timing. The combining timing acquisition unit 108 sends the acquired combining timing to the combining timing determination unit 109.

Subsequently, the combining timing determination unit 109 determines a combining timing for combining the first drive signal and the second drive signal based on the acquired combining timing. The first drive signal output unit 103 and the second drive signal output unit 106 generate the first drive signal and the second drive signal, respectively (Step S3), and send the generated first drive signal and second drive signal to the composite drive signal generation unit 110. Furthermore, the first drive signal output unit 103 and the second drive signal output unit 106 send the generated first drive signal and second drive signal to the operation control unit 111, respectively.

Subsequently, at the combining timing determined by the combining timing determination unit 109, the composite drive signal generation unit 110 generates the composite drive signal from the generated first drive signal and second drive signal (Step S4). The composite drive signal generation unit 110 sends the generated composite drive signal to the operation control unit 111.

In Step S5, the operation control unit 111 controls the conveyor device 10 and the industrial machine 20 based on the first drive signal, the second drive signal, and the composite drive signal. When the composite drive signal is not generated, the operation control unit 111 controls the conveyor device 10 and the industrial machine 20 based on the first drive signal and the second drive signal.

Next, a program of the present disclosure will be described. Each constitution included in the operation controller 1 can be implemented by hardware, software, or a combination of those. Note here that “implemented by software” means that the program is loaded and executed by a computer.

The program may be supplied to the computer by being housed in various types of non-transitory computer readable media. The non-transitory computer readable media include various types of tangible storage media. Examples of the non-transitory computer readable media may be magnetic recording media (for example, a flexible disk, a magnetic tape, and a hard disk drive), magneto-optical media (for example, a magneto-optical disk), a CD-ROM (Read Only Memory), a CD-R, a CD-R/W, and semiconductor memories (for example, a mask ROM, a PROM (Programmable ROM), an EPROM (Erasable PROM), a flash ROM, and a RAM (random access memory)). Furthermore, the display program may also be supplied to the computer by various types of transitory computer readable media. Examples of the transitory computer readable media may be an electrical signal, an optical signal, and an electromagnetic wave. The transitory computer readable media can supply the program to the computer via a wired communication pathway such as an electric cable and an optical fiber or via a wireless communication pathway.

As described above, the operation controller 1 and the program according to the first embodiment can achieve the following effects.

(1) The operation controller 1 controlling the operation of the production system 100 including the industrial machine 20 by using the drive signals of at least 2 paths, and the operation controller includes: the first drive signal output unit 103 that outputs the first drive signal as the first path drive signal; the second drive signal output unit 106 that outputs the second drive signal as the second path drive signal; the composite drive signal generation unit 110 that generates the composite drive signal by combining the first drive signal and the second drive signal; and the operation control unit 111 that controls the operation of the production system 100 based on the first drive signal, the second drive signal, and the composite drive signal. Since the operation of the production system 100 is controlled based on the composite drive signal in addition to the first drive signal and the second drive signal, the drive signals of 2 paths can be operated appropriately. Therefore, the drive signals of 2 paths can be combined with each other appropriately.

(2) The operation controller 1 further includes the combining timing determination unit 109 that determines the combining timing of the first drive signal and the second drive signal. The composite drive signal generation unit 110 generates the composite drive signal by combining the first drive signal and the second drive signal based on the determined combining timing. Thereby, it is possible to combine the first path drive signal and the second path drive signal at the determined combining timing. Therefore, it is possible to generate a suitable composite drive signal even from the first drive signal and the second drive signal of different combining timings. Thereby, the general purpose property of the operation controller 1 can be improved.

(3) The operation controller 1 further includes the selection acquisition unit 107 that acquires selection regarding whether to generate the composite drive signal. The composite drive signal generation unit 110 generates the composite drive signal, when the selection to generate the composite drive signal is acquired. This makes it possible to select whether to generate the composite drive signal, so that flexibility of control can be improved.

(4) As the composite drive signal, the composite drive signal generation unit 110 generates the composite drive signal for changing the relative position of the object controlled by the second drive signal with respect to the position of the object controlled by the first drive signal. Thereby, the relative position of one object can be changed with respect to the other object, so that it is possible to make the first drive signal and the second drive signal correspond appropriately.

(5) As the composite drive signal, the composite drive signal generation unit 110 generates the composite drive signal for changing the relative position of the tool 21 controlled by the second drive signal with respect to the position of the workpiece W transferred by the first drive signal. Thereby, the relative position of the tool 21 can be changed in accordance with transfer of the workpiece W, so that it is possible to make the first drive signal and the second drive signal correspond appropriately.

(6) As the composite drive signal, the composite drive signal generation unit 110 generates the composite drive signal for compensating a difference between the position of the workpiece W transferred by the first drive signal and the position of the tool 21 controlled by the second drive signal. Thereby, it is possible to compensate the difference generated due to the discrepancy in the execution timings of the first drive signal and the second drive signal. Therefore, it is possible to make the workpiece W and the tool 21 correspond appropriately.

### Second Embodiment

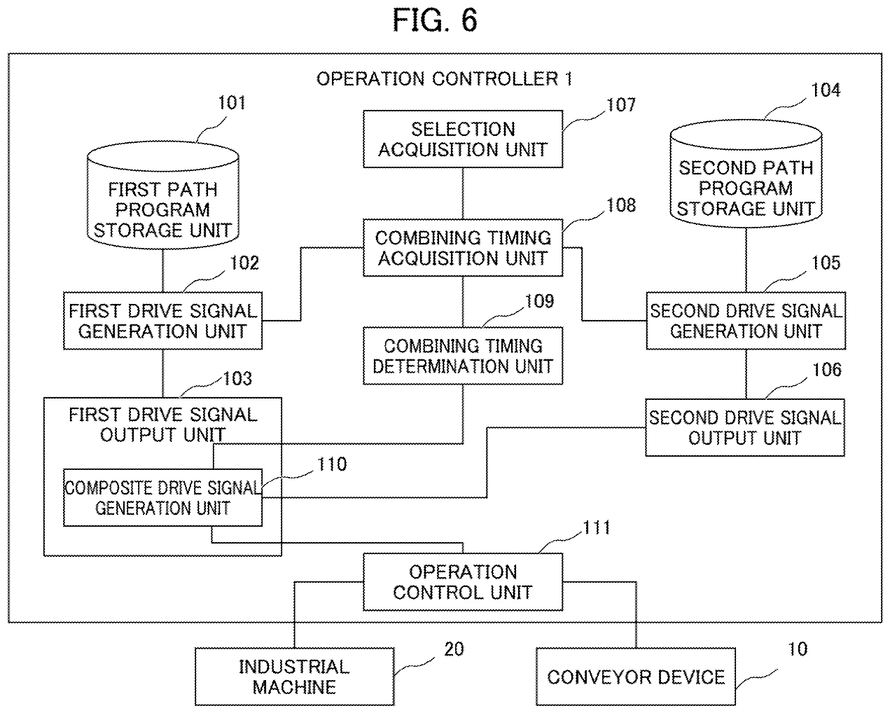

Next, the operation controller 1 and the program according to a second embodiment of the present disclosure will be described by referring to FIG. 6. For describing the second embodiment, same reference numerals are applied to the constitution elements same as those of the embodiment described above, and description thereof are omitted or simplified. As illustrated in FIG. 6, the operation controller 1 and the program according to the second embodiment are different from those of the first embodiment in respect that the second drive signal output unit 106 outputs the second drive signal to the first drive signal output unit 103. The operation controller 1 and the program according to the second embodiment are different from those of the first embodiment in respect that the composite drive signal generation unit 110 generates the composite drive signal in the first drive signal output unit 103. Furthermore, the operation controller 1 and the program according to the second embodiment are different from those of the first embodiment in respect that the first drive signal output unit 103 outputs the first drive signal, the second drive signal, and the composite drive signal by using a control frequency shorter than the output of the second drive signal.

As described above, the operation controller 1 and the program according to the second embodiment achieve the following effects.

(7) The second drive signal output unit 106 outputs the second drive signal to the first drive signal output unit 103, the composite drive signal generation unit 110 generates the composite drive signal in the first drive signal output unit 103 by using the second drive signal, and the first drive signal output unit 103 outputs the first drive signal, the second drive signal, and the composite drive signal by using a control frequency shorter than the output of the second drive signal. Thereby, the first drive signal, the second drive signal, and the composite drive signal can be output to the operation control unit 111 with a still shorter control frequency. Therefore, it is possible to implement still more delicate machining by increasing the control timings still more.

### Third Embodiment

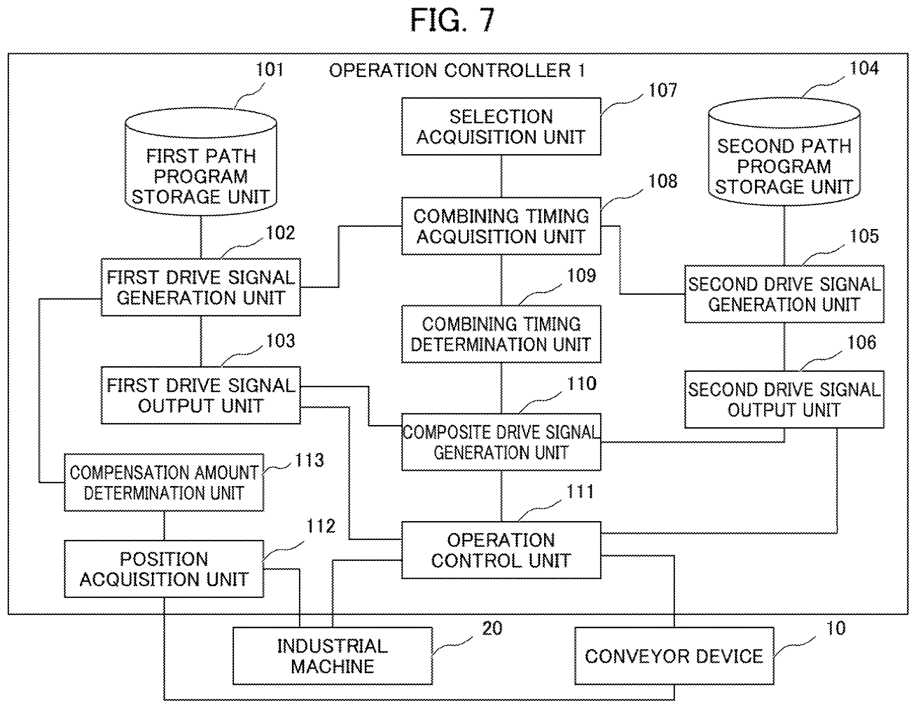

Next, the operation controller 1 and the program according to a third embodiment of the present disclosure will be described by referring to FIG. 7. For describing the third embodiment, same reference numerals are applied to the constitution elements same as those of the embodiments described above, and description thereof are omitted or simplified. As illustrated in FIG. 7, the operation controller 1 and the program according to the third embodiment are different from those of the first and second embodiments in respect that a position acquisition unit 112 for acquiring position information of the tool 21 with respect to the workpiece W is further provided. Furthermore, the operation controller 1 and the program according to the third embodiment are different from those of the first and second embodiments in respect that a compensation amount determination unit 113 for determining a compensation amount for compensating the stroke of the object based on the acquired position is further provided. Furthermore, the operation controller 1 and the program according to the third embodiment are different from those of the first and second embodiments in respect that the operation control unit 111 controls the production system 100 based on the first drive signal including the determined compensation amount, the second drive signal, and the composite drive signal.

The position acquisition unit 112 is implemented by an operation of the CPU, for example. The position acquisition unit 112 acquires the position of the tool 21 on a workpiece coordinate system, for example. Furthermore, the position acquisition unit 112 acquires the position of the tool 21 with respect to the workpiece W based on the output signal of a sensor that acquires the position of the tool 21, for example.

The compensation amount determination unit 113 is implemented by an operation of the CPU, for example. The compensation amount determination unit 113 determines the compensation amount (feedback amount) of the composite drive signal in accordance with the relative positions of the workpiece W and the tool 21. The compensation amount determination unit 113 sends the determined compensation amount to the first drive signal generation unit 102. Thereby, the compensation amount determination unit 113 causes the first drive signal generation unit 102 to generate the first drive signal including the determined compensation amount. The operation control unit 111 controls the production system 100 based on the first drive signal including the determined compensation amount, the second drive signal, and the composite drive signal.

As described above, the operation controller 1 and the program according to the third embodiment can achieve the following effects.

(8) The operation controller 1 further includes: the position acquisition unit 112 that acquires position information of the tool 21 with respect to the workpiece W; and the compensation amount determination unit 113 that determines the compensation amount for compensating a stroke of the object based on the acquired position. The operation control unit 111 controls the production system 100 based on the first drive signal including the determined compensation amount, the second drive signal, and the composite drive signal. Thereby, control capable of flexibly corresponding to the change in the shape of the workpiece W can be implemented. Therefore, it is possible to improve the machine accuracy of the production system 100.

While the preferred embodiments of each of the operation controller 1 and the program of the present disclosure have been described above, the present disclosure is not limited by the above-described embodiments and modifications thereof are possible as appropriate.

For example, in the embodiments described above, the operation of the combining timing acquisition unit 108 is not limited to acquiring the combining timing input to the input device (not shown) such as the keyboard. The combining timing acquisition unit 108 may acquire set combining timings from another program or the like.

Furthermore, while the first drive signal and the second drive signal are described in the embodiments above as the PLC for transferring the workpiece W and the NC for driving the tool 21, respectively, the first and second drive signals are not limited thereto. The first drive signal may be the NC for transferring the workpiece W or may be the PLC for performing simple machining on the workpiece W, for example.

Furthermore, while the operation controller 1 that controls the operations by using the drive signals of 2 paths is described in the embodiments above, the operation controller 1 is not limited thereto. The operation controller 1 may control the operations by using the drive signals of 3 paths or more. For example, the operation controller 1 may control the operation by using the drive signals of 3 paths or more, while having the operation of each of the tools 21 of a plurality of industrial machines 20 as 1 path.

Furthermore, in the embodiments described above, the composite drive signal generation unit 110 may output only the first drive signal and the second drive signal to the operation control unit 111 without generating the composite drive signal, when the first drive signal and the second drive signal are not combined.

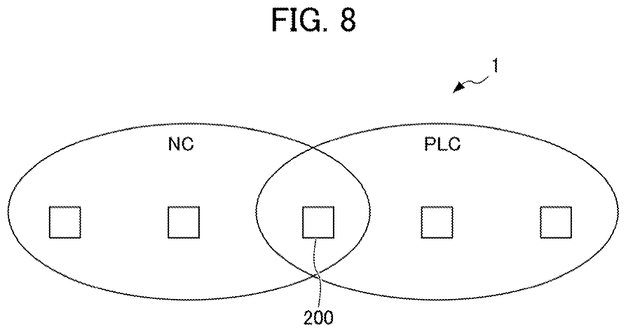

Furthermore, while the first path is described as the PLC and the second path is described as the NC in the embodiments above, the first and second paths are not limited thereto. As illustrated in FIG. 8, the production system 100 may include a constitution (a shared axis 200) that is in common to the first path and the second path. That is, the production system 100 may include the shared axis 200 that can be operated by any of the first drive signal, the second drive signal, and the composite drive signal. The selection acquisition unit 107 may acquire selection of either the first drive signal or the second drive signal as the signal to operate the shared axis 200, when the composite drive signal is not generated (when selection of “not combine” is acquired). The selection acquisition unit 107 may select either the first drive signal or the second drive signal to operate the shared axis 200 based on input from outside, a command value included in the first drive signal, or a command value included in the second drive signal. Furthermore, each of the first drive signal output unit 103 and the second drive signal output unit 106 may independently output the first drive signal or the second drive signal for the shared axis 200.

Furthermore, while the combining timing determination unit 109 is described in the embodiments above to combine the first drive signal and the second drive signal based on the acquired combining timing, the combining timing is not limited thereto. The operation controller 1 may not include the combining timing acquisition unit 108 and the combining timing determination unit 109. In this case, each of the first drive signal output unit 103 and the second drive signal output unit 106 may output the first drive signal and the second drive signal, for which the combining timing is considered in advance. The composite drive signal generation unit 110 may generate the composite signal by superimposing the output first drive signal and second drive signal as they are.

### EXPLANATION OF REFERENCE NUMERALS

1 Operation controller
20 Industrial machine
21 Tool
100 Production system
103 First drive signal output unit
106 Second drive signal output unit
107 Selection acquisition unit
109 Combining timing determination unit
110 Composite drive signal generation unit
111 Operation control unit
112 Position acquisition unit
113 Compensation amount determination unit
W Workpiece

1. An operation controller controlling an operation of a production system including an industrial machine by using drive signals of at least 2 paths, the operation controller comprising:
a first drive signal output unit that outputs a first drive signal as a drive signal of a first path;
a second drive signal output unit that outputs a second drive signal as a drive signal of a second path;
a composite drive signal generation unit that generates a composite drive signal by combining the first drive signal and the second drive signal; and
an operation control unit that controls the operation of the production system based on the first drive signal, the second drive signal, and the composite drive signal.

2. The operation controller according to claim 1, further comprising a combining timing determination unit that determines a combining timing for combining the first drive signal and the second drive signal, wherein
the composite drive signal generation unit generates the composite drive signal by combining the first drive signal and the second drive signal based on the determined combining timing.

3. The operation controller according to claim 1, further comprising a selection acquisition unit that acquires selection regarding whether to generate the composite drive signal, wherein
the composite drive signal generation unit generates the composite drive signal, when the selection to generate the composite drive signal is acquired.

4. The operation controller according to claim 1, wherein the composite drive signal generation unit generates the composite drive signal by combining the first drive signal and the second drive signal while a prescribed compensation being applied to at least one of the first drive signal and the second drive signal.

5. The operation controller according to claim 1, wherein the second drive signal output unit outputs the second drive signal to the first drive signal output unit;
the composite drive signal generation unit generates the composite drive signal in the first drive signal output unit by using the second drive signal; and
the first drive signal output unit outputs the first drive signal, the second drive signal, and the composite drive signal by using a control frequency shorter than the output of the second drive signal.

6. The operation controller according to claim 1, further comprising:
a position acquisition unit that acquires position information of a tool with respect to a workpiece; and
a compensation amount determination unit that determines a compensation amount for compensating a stroke of an object based on the acquired position, wherein
the operation control unit controls the production system based on the first drive signal including the determined compensation amount, the second drive signal, and the composite drive signal.

7. A recording medium which non-transitorily records a program causing a computer to function as an operation controller that controls an operation of a production system including an industrial machine by using drive signals of at least 2 paths,
the program causing the computer to function as:
a first drive signal output unit that outputs a first drive signal as a drive signal of a first path;
a second drive signal output unit that outputs a second drive signal as a drive signal of a second path;
a composite drive signal generation unit that generates a composite drive signal by combining the first drive signal and the second drive signal; and
an operation control unit that controls axis movement of the industrial machine based on the first drive signal, the second drive signal, and the composite drive signal.
